(19) United States
(12) Patent Application Publication
(10) Pub. No.: US 2018/0110358 A1
(43) Pub. Date: Apr. 26, 2018

(54) AUTOMATED DEVICE TO PREPARE BEVERAGES FROM CARTRIDGES

(71) Applicant: ILLYCAFFE' S.P.A. CON UNICO SOCIO, Trieste (IT)

(72) Inventors: Riccardo Piras, Monza (IT); Furio Suggi Liverani, Trieste (IT); Eleuterio Proia, Gradisca d'lsonzo (IT); Maurizio Gasparin, Pordenone (IT); Cosimo Fusco, Trieste (IT)

(73) Assignee: ILLYCAFFE' S.P.A. CON UNICO SOCIO, Trieste (IT)

(21) Appl. No.: 15/559,036

(22) PCT Filed: Mar. 17, 2016
(86) PCT No.: PCT/EP2016/055895

§ 371 Date: Sep. 15, 2017

(30) Foreign Application Priority Data
Mar. 17, 2015 (IT) UD2015A000036

(51) Int. Cl. A47J 31/36; A47J 31/40

(52) U.S. Cl. CPC A47J 31/3633; A47J 31/3642; A47J 31/3638; A47J 31/407

(57) ABSTRACT

Automated device to prepare beverages from cartridges includes a beverage extraction unit configured to extract and deliver the beverage from a cartridge that comprises a cartridge feeder chamber configured to contain and supply a plurality of cartridges, a cartridge transfer slider, automatically mobile between at least a cartridge loading position, in correspondence with the cartridge feeder chamber, to receive a cartridge, a beverage extraction position, different from the cartridge loading position, aligned with the beverage extraction unit and a cartridge expulsion position, different from the cartridge loading position and from the beverage extraction position. The cartridge transfer slider has, both in the cartridge loading position and in the beverage extraction position, a cartridge support configuration, and also has, in the cartridge expulsion position, a cartridge release configuration to discharge a used cartridge.

### FIELD OF THE INVENTION

Embodiments described here concern an automated device to prepare beverages from cartridges containing a substance in powder form, which can be used in a machine for the preparation of coffee or other beverages.

In particular, embodiments described here concern a device able to automatically perform the operations of loading a cartridge, extracting the beverage by percolating hot water under pressure through the powder substance contained in the cartridge and discharging the used cartridges at the end of the extraction step.

Such embodiments concern an automated device that can be used in any machine to prepare espresso coffee, or other machines which require to feed cartridges of this type.

### BACKGROUND OF THE INVENTION

It is known to prepare a coffee drink using powdered coffee obtained by grinding coffee beans. The coffee drink, hereafter also called simply coffee, is generally obtained by extraction, that is, percolation with boiling water under pressure.

It is known in particular to use machines for the production of coffee using cartridges containing the powdered coffee. The cartridges can be made for example of metal, plastic, biodegradable plastic or other biodegradable or compostable materials, such as for example polylactic acid (PLA).

In general, the passes to extract the coffee-based drink from an espresso coffee machine comprise a step in which hot water or pressurized steam is introduced into an extraction chamber, a step of infusing the coffee with hot water or pressurized steam, and a step of delivering the beverage thus obtained into a collection container, for example a mug or cup, a glass or other suitable container, so that it is ready to be drunk.

One disadvantage of such machines for preparing coffee is that the cartridges have to be introduced manually, for every operation to deliver the coffee, inside an extraction chamber. That is, it is necessary to introduce a respective cartridge manually into the machine every time a dose of coffee is prepared.

After the coffee has been delivered, moreover, the used cartridges have to be removed and eliminated, and this normally happens manually.

This prevents a continuous and quick use of such machines, because the operations to load and discharge the cartridges take up some time.

Another disadvantage of these machines is that they can have problems when cartridges are used that have to be inserted into the extraction chamber in a particular direction of insertion.

One attempt to control the direction of insertion is to use shaped guide or lead-in members, associated with the extraction chamber, but when it is necessary to use the machines continuously, for example when a series of coffees has to be prepared quickly in a bar or coffee shop, it may happen that the operator does not take the necessary care, and problems of blockages, sticking and incorrect preparation may arise.

Another possible disadvantage may be when the machine for preparing espresso coffee is used by several people or operators, for example in a bar or coffee shop, and it may happen that one user forgets to remove the used cartridge from the extraction chamber before inserting another one.

In this case too, problems of blockages or sticking may arise, because of the used cartridge that has not been removed, with consequent damage to the machine and a slow-down in the supply of espresso drinks.

Document US-A-2011/0041701 describes an automatic conveyor of pods and a unit for the preparation of hot beverages.

Document US-A-2003/0071056 describes a cartridge expeller for a drink dispensing machine.

Document JP-A-2001 155241 describes a device for housing products in cartridges for a vending machine, able to correct the direction of a product in cartridges from an improper direction in a housing cylinder to a correct direction.

Document WO-A-2006/059015 describes a pod dispenser provided with a vertical guide support that contains stacked pods.

There is therefore a need to perfect an automated device for the preparation of beverages from cartridges that can overcome at least one of the disadvantages of the state of the art.

In particular, one purpose of the present invention is to obtain an automated device for the preparation of beverages in which it is not necessary to insert the cartridges manually inside the extraction chamber of a machine for the preparation of coffee or other beverages every single time the coffee is delivered.

Another purpose of the present invention is to obtain an automated device for the preparation of beverages which is able to automatically discharge the used cartridge, without obliging the operator to remove it before being able to carry out another operation to deliver the coffee or other drink.

Another purpose of the present invention is to obtain an automated device for the preparation of beverages from cartridges which is universal, that is, it can be inserted inside different types of machine for delivering coffee and/or other beverages that use cartridges containing powdered substances.

Another purpose of the present invention is to obtain a device that is simple to use and, for use, does not require particular knowledge of machines that use cartridges.

The Applicant has devised, tested and embodied the present invention to overcome the shortcomings of the state of the art and to obtain these and other purposes and advantages.

Other limitations and disadvantages of conventional solutions and technologies will be clear to a person of skill after reading the remaining part of the present description with reference to the drawings and the description of the embodiments that follow, although it is clear that the description of the state of the art connected to the present description must not be considered an admission that what is described here is already known from the state of the prior art.

### SUMMARY OF THE INVENTION

The present invention is set forth and characterized in the independent claims, while the dependent claims describe other characteristics of the invention or variants to the main inventive idea.

In accordance with some embodiments, an automated device is provided to prepare beverages from cartridges. According to one embodiment, the device comprises:
a beverage extraction unit configured to extract and deliver the beverage from a cartridge,
a cartridge feeder chamber configured to contain and supply a plurality of cartridges,
a cartridge transfer slider, automatically mobile between at least:
   a cartridge loading position, in correspondence with the cartridge feeder chamber, to receive a cartridge;
   a beverage extraction position, different from the cartridge loading position, aligned with the beverage extraction unit;
   a cartridge expulsion position, different from the cartridge loading position and from the beverage extraction position.

According to the present invention, the cartridge transfer slider has, both in the cartridge loading position and also in the beverage extraction position, a cartridge support configuration, and also has, in the cartridge expulsion position, a cartridge release configuration to discharge a used cartridge.

According to other embodiments, the cartridge transfer slider comprises a front semi-shell and a rear semi-shell that, when they are joined, define the cartridge support configuration of the cartridge transfer slider and define a concave seating configured to support the cartridge. When they are separated, they define the cartridge release configuration of the cartridge transfer slider and allow the discharge of the used cartridge.

According to other embodiments, the front semi-shell and the rear semi-shell are joined by means of releasable attachment members.

According to other embodiments, the automated device for the preparation of beverages from cartridges comprises movement members configured to actuate the move of said cartridge transfer slider at least in the cartridge loading position, beverage extraction position and cartridge expulsion position.

According to other embodiments, the beverage extraction unit comprises an extraction head, configured to extract a beverage from a cartridge, and a positioning unit configured to position the extraction head in proximity to the cartridge when the cartridge transfer slider is in the beverage extraction position.

Other embodiments concern a cartridge transfer slider for an automated device for the preparation of beverages from cartridges. According to one embodiment the slider is configured mobile and has at least:
a cartridge loading position, to receive a cartridge,
a beverage extraction position, different from said cartridge loading position;
said cartridge transfer slider having, both in said cartridge loading position and in said beverage extraction position, a cartridge support configuration,
a cartridge expulsion position, different from the cartridge loading position and from the beverage extraction position, wherein said cartridge transfer slider has a cartridge release configuration for the discharge of said used cartridge.

In accordance with other embodiments, an automated method for the preparation of beverages from cartridges is provided. According to one embodiment the method comprises:
containing and supplying a plurality of cartridges using a cartridge feeder chamber,
automatically receiving a cartridge in a cartridge loading position, in correspondence with the cartridge feeder chamber;
automatically transferring the cartridge into a beverage extraction position, aligned with a beverage extraction unit and different from said cartridge loading position, for the extraction and delivery of the beverage;
after the extraction, automatically transferring the used cartridge into a cartridge expulsion position, different from the cartridge loading position and from the beverage extraction position, in which to discharge the cartridge.

These and other aspects, characteristics and advantages of the present disclosure will be better understood with reference to the following description, drawings and attached claims. The drawings, which are integrated and form part of the present description, show some embodiments of the present invention, and together with the description, are intended to describe the principles of the disclosure.

The various aspects and characteristics described in the present description can be applied individually where possible. These individual aspects, for example aspects and characteristics described in the description or in the attached dependent claims, can be the object of divisional applications.

It is understood that any aspect or characteristic that is discovered, during the patenting process, to be already known, shall not be claimed and shall be the object of a disclaimer.

### BRIEF DESCRIPTION OF THE DRAWINGS

These and other characteristics of the present invention will become apparent from the following description of some embodiments, given as a non-restrictive example with reference to the attached drawings wherein:

FIG. 1 is a perspective view of an automated device for the preparation of beverages from cartridges in accordance with embodiments described here;

FIG. 2 is a perspective view of the inside of the automated device of FIG. 1 for the preparation of beverages from cartridges;

FIG. 3 is a view in longitudinal section along the section plane A of FIG. 1 of embodiments of an automated device for the preparation of beverages from cartridges;

FIG. 4 is a cross section view along the line IV of FIG. 3 of a detail of the automated device for the preparation of beverages from cartridges in an inactive position;

FIG. 5 is a section view along the section plane A of FIG. 1 of a detail of the automated device for the preparation of beverages from cartridges in an inactive position;

FIG. 6 is a section view along the section plane A of FIG. 1 of a detail of the automated device for the preparation of beverages from cartridges in a cartridge loading position;

FIG. 7 is a section view along the section plane A of FIG. 1 of a detail of the automated device for the preparation of beverages from cartridges in a cartridge extraction position;

FIG. 8 is a section view along the section plane A of FIG. 1 of the detail of FIG. 7 in a different operating condition;

FIG. 9 is an enlarged detail of the automated device for the preparation of beverages from cartridges in the cartridge loading position along the section plane C of FIG. 1;

FIG. 10 is an enlarged detail of the automated device for the preparation of beverages from cartridges in the cartridge expulsion position along the section plane C of FIG. 1;

FIG. 11 is a section view along the section plane B of FIG. 1 of a detail of the automated device for the preparation of beverages from cartridges toward a cartridge expulsion position;

FIG. 12 is an enlarged detail of the automated device for the preparation of beverages from cartridges in a cartridge expulsion position along the section plane B of FIG. 1;

FIG. 13 is a perspective view of a cartridge transfer slider in accordance with embodiments described here;

FIGS. 14, 15 and 16 are perspective views of a cartridge transfer slider in accordance with embodiments described here in cooperation with a beverage extraction unit;

FIGS. 17 and 18 are perspective views of a cartridge transfer slider in accordance with embodiments described here;

FIG. 19 is a perspective view of an automated device for the preparation of beverages from cartridges in accordance with other embodiments described here;

FIG. 20 is a perspective view of an automated device for the preparation of beverages from cartridges in accordance with embodiments described here in a condition in which the cartridge feeder chamber is removed;

FIG. 21 is a perspective view of a cartridge feeder chamber of the automated device for the preparation of beverages from cartridges in accordance with embodiments described here;

FIG. 22 is a perspective view of part of a cartridge feeder chamber of the automated device for the preparation of beverages from cartridges in accordance with embodiments described here;

FIG. 23 is a perspective view of another part of a cartridge feeder chamber of the automated device for the preparation of beverages from cartridges in accordance with embodiments described here;

FIG. 24 is a rear view of a cartridge feeder chamber of the automated device for the preparation of beverages from cartridges in accordance with embodiments described here;

FIG. 25 is a cross section along the line XXV-XXV of FIG. 24;

FIG. 26 is a cross section along the line XXVI-XXVI of FIG. 24;

FIG. 27 is a cross section along the line XXVII-XXVII of FIG. 24;

FIG. 28 is a cross section along the line XXVIII-XXVIII of FIG. 27.

To facilitate comprehension, the same reference numbers have been used, where possible, to identify identical common elements in the drawings. It is understood that elements and characteristics of one embodiment can conveniently be incorporated into other embodiments without further clarifications.

### DETAILED DESCRIPTION OF SOME EMBODIMENTS

We shall now refer in detail to the various embodiments of the present invention, of which one or more examples are shown in the attached drawings. Each example is supplied by way of illustration of the invention and shall not be understood as a limitation thereof. For example, the characteristics shown or described insomuch as they are part of one embodiment can be adopted on, or in association with, other embodiments to produce another embodiment. It is understood that the present invention shall include all such modifications and variants.

Before describing these embodiments, we must also clarify that the present description is not limited in its application to details of the construction and disposition of the components as described in the following description using the attached drawings. The present description can provide other embodiments and can be obtained or executed in various other ways. We must also clarify that the phraseology and terminology used here is for the purposes of description only, and cannot be considered as limitative. The use of terms such as “including”, “comprising”, “having” and their variations is intended to include the elements listed after them and their equivalents, and also additional elements. Unless otherwise specified, terms such as “mounted”, “connected”, “supported” and “coupled” and their variations are used in the widest sense and include both direct and indirect assemblies, connections, supports and couplings. Furthermore, the terms “connected” and “coupled” cannot be limited to physical or mechanical connections or couplings.

Embodiments described here refer to an automated device 10 for the preparation of beverages from cartridges, usable in a machine for the preparation of coffee, or other beverages, that uses cartridges containing a substance in powder form so as to obtain the desired beverage by means of hot infusion, that is, a percolation with boiling water and/or steam under pressure. Examples of other beverages, aside from coffee, can be tea, chocolate, tisanes, infusions, for example of herbs, fruit or other vegetables, milk or similar or comparable food products to be consumed in the form of a beverage. The cartridges discussed here can be made of metal, plastic, biodegradable plastic, or other biodegradable or compostable material, such as polylactic acid (PLA).

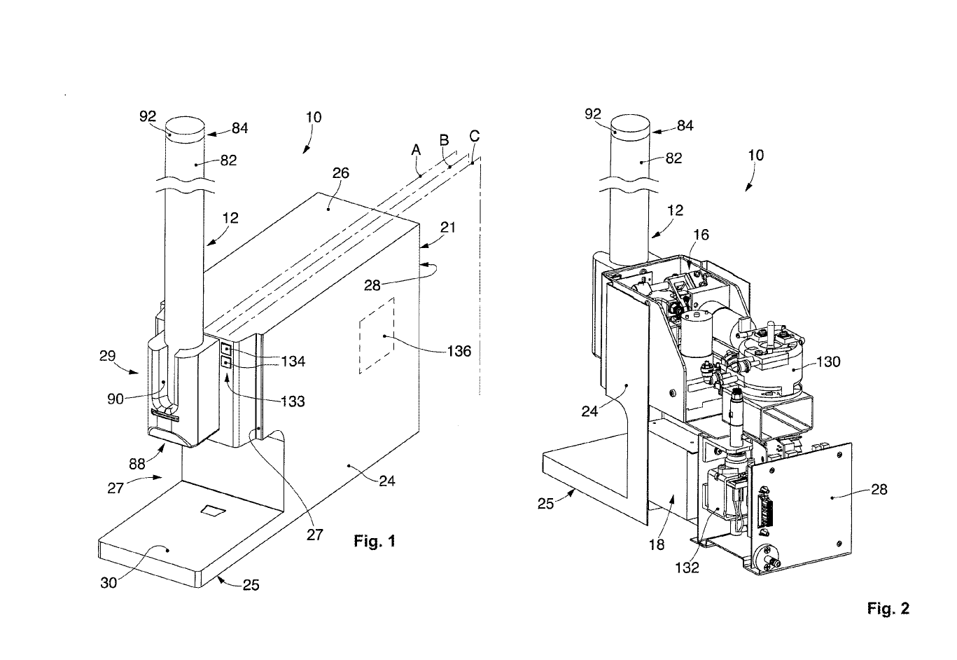

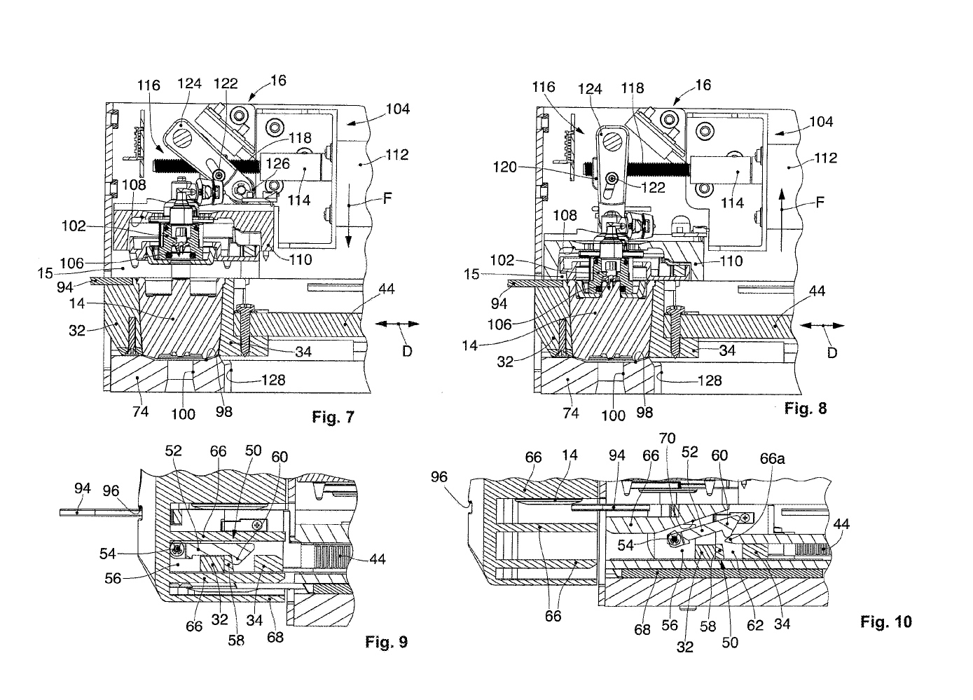

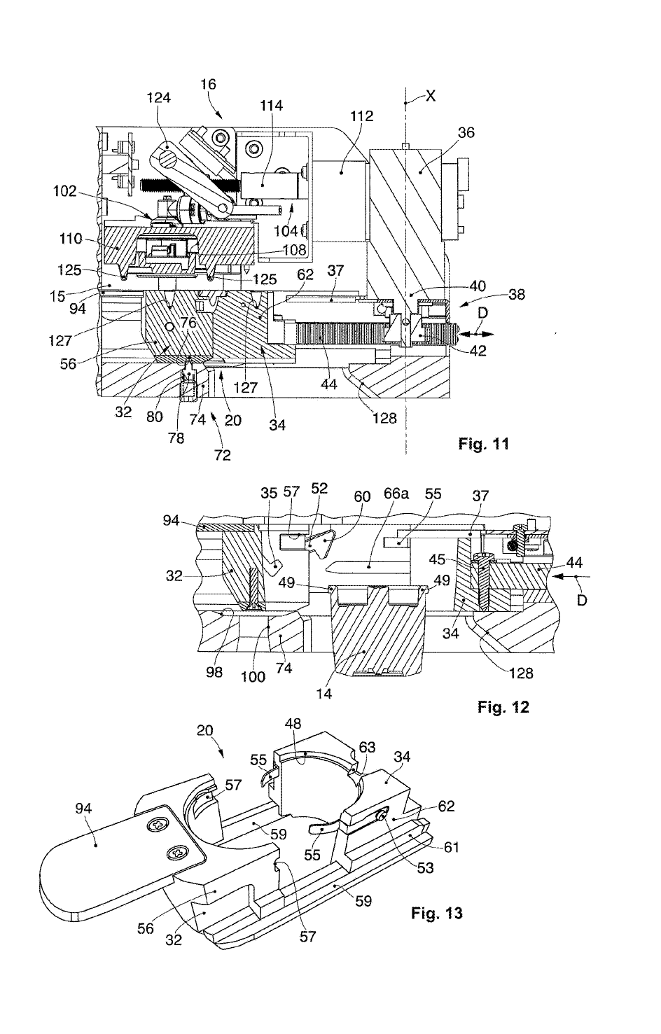

FIGS. 1-3 are used to describe embodiments, combinable with all the embodiments described here, of the device 10 that includes a beverage extraction unit 16, configured to extract and deliver the beverage from a cartridge 14. The device 10 also includes:
a cartridge feeder chamber or cartridge loader 12, configured to contain and supply a plurality of cartridges 14,
a cartridge transfer slider 20 automatically mobile between at least:
   a cartridge loading position, in correspondence with the cartridge feeder chamber 12 to receive a cartridge 14 (see for example FIG. 6),
   a beverage extraction position, different from the cartridge loading position, aligned with the beverage extraction unit 16 (see for example FIGS. 7 and 8), to allow the delivery of the beverage;
   a cartridge expulsion position, different from the cartridge loading position and the beverage extraction position,
      wherein the cartridge transfer slider 20 has, both in the cartridge loading position and in the beverage extraction position, a cartridge support configuration, and also has, in the cartridge expulsion position, a cartridge release configuration to discharge a used cartridge 14 (see for example FIGS. 11 and 12).

By the expression “in an automatic manner”, “automatically”, “automated”, or similar, here and hereafter, we mean that the cartridge transfer slider 20 can receive a cartridge 14, transfer it to a beverage extraction position, and subsequently expel the used cartridge 14 to a cartridge expulsion position, without needing any intervention by an operator or user.

According to some embodiments, the device 10 can also comprise a water supply, usable to produce coffee or other beverage, for example a tank containing water and a hydraulic circuit, provided to take the water from the tank to the extraction head to be able to carry out the percolation and delivery operations of the beverage. The tank containing the water and the hydraulic circuit that allow to feed the water to the beverage extraction unit 16 can be the known type and not shown in the drawings.

According to embodiments described using FIGS. 1-3, the device 10 comprises an external containing shell 21 which has lateral walls 24, connected with respect to each other at the lower part by a base 25 and at the upper part by an upper wall 26.

The cartridge feeder chamber 12 is disposed at the front of the external containing shell 21. The external containing shell 21 is provided internally with an extraction chamber 15. The extraction chamber 15 is configured to house a cartridge 14 in its beverage extraction position, where the beverage extraction unit 16 is provided to act to allow the delivery of the beverage.

The lateral walls 24, the base 25 and the upper wall 26 of the external containing shell 21 are joined to a front part 27, provided in correspondence to the cartridge feeder chamber 12, and a rear part 28, opposite the front part 27, in order to define a volume V of the external containing shell 21 that contains inside it the cartridge feeder chamber 12, the beverage extraction unit 16 and the cartridge transfer slider 20. In particular, the cartridge feeder chamber 12 is disposed on the front part 27 of the external containing shell 21.

In some embodiments, combinable with all the embodiments described here, the device 10 can also include a cartridge discharge chamber 18, configured to receive the used cartridges 14. In possible implementations, the volume V of the external containing casing 21 also contains the cartridge discharge chamber 18.

The front part 27, above, has a protruding containing body 29 which internally houses the beverage extraction unit 16, and externally supports the cartridge feeder chamber 12 which is solidly attached to it. In this case, therefore, the cartridge feeder chamber 12 is disposed on the protruding containing body 29.

The front part 27, lower down, has a support base 30 that extends from the beverage extraction unit 16 to beyond the extension of than the cartridge feeder chamber 12, and is configured to support a mug, a cup, a glass, or any receptacle suitable to receive the beverage obtained through the percolation of hot water under pressure through a cartridge 14.

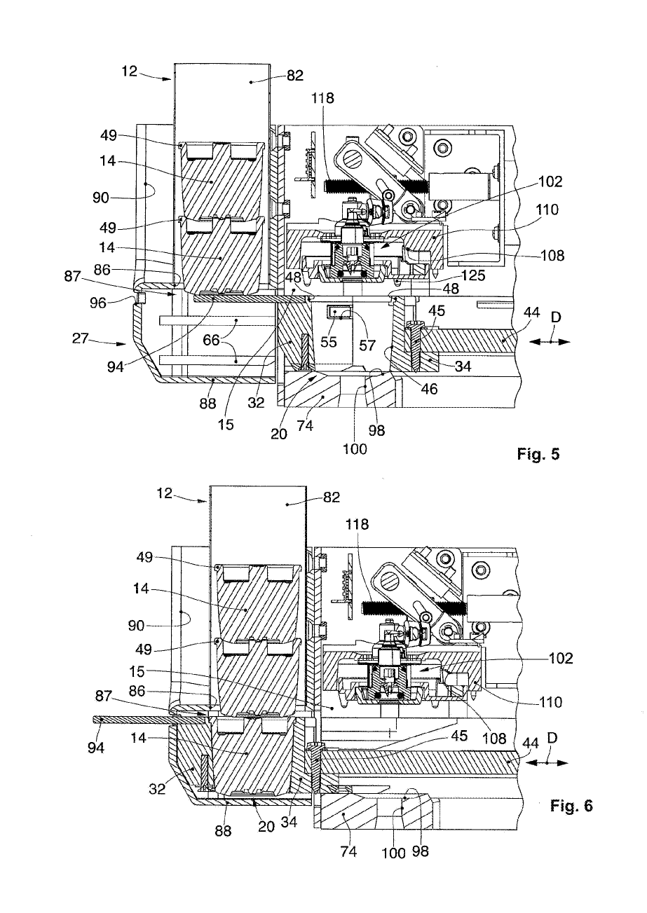

In possible implementations, the cartridge transfer slider 20 can also assume an inactive position, in which it does not support any cartridge 14. According to embodiments described using FIGS. 4 and 5, the inactive position can coincide with the beverage extraction position.

According to a variant, the inactive position can be different from the beverage extraction position, for example it could be in an intermediate position between the cartridge loading position and the beverage extraction position.

Embodiments described using FIGS. 4-12 can provide that the cartridge support configuration of the cartridge transfer slider 20 can be an assembled configuration, while the cartridge release configuration can be a disassembled configuration thereof.

According to a variant, the support configuration of the cartridge transfer slider 20 provides to support a cartridge 14 supplying a support base, while in the cartridge release configuration it can be overturned or upended, so as to no longer supply a support base.

According to embodiments described using FIGS. 4-12, the cartridge transfer slider 20 can assume an assembled configuration and a disassembled configuration.

The cartridge transfer slider 20 can comprise a front semi-shell, or semi-slider 32, and a rear semi-shell or semi-slider 34, which, in the assembled configuration of the cartridge transfer slider 20, are releasably joined to each other, while in the disassembled configuration of the cartridge transfer slider 20 they are separated, at least partly. In particular, this separation is suitable so that the cartridge 14 is no longer adequately supported by the cartridge transfer slider 20, or by portions thereof, and can fall freely due to the effect of gravity and/or suitable extractors, thrusters, ejectors or similar members, in order to discharge it.

When the cartridge transfer slider 20 is in the assembled configuration, the front semi-shell 32 and the rear semi-shell 34 define with respect to each other a concave seating 46, configured to receive and support a cartridge 14.

In accordance with some embodiments, in correspondence with their upper profile, the front semi-shell 32 and the rear semi-shell 34 have a groove 48, shaped so as to create a support long the edge, such as to adapt to the profile of the upper part of a cartridge 14.

The cartridge 14 can be inserted in the concave seating 46 and be supported by means of the groove 48. The cartridges 14, in fact, can have an upper profile with a protruding edge 49 or collar, which projects toward the outside, so as to create a protuberance with which to rest on a complementary profile, in this case on the groove 48 of the concave seating 46.

According to possible embodiments, the cartridges 14 can have a truncated cone conformation, complementary to the concave seating 46.

In possible implementations, the concave seating 46 is delimited only laterally by means of the joined front semi-shell 32 and the rear semi-shell 34. The concave seating 46 is open, at the upper part, to be able to house the cartridge 14 and at the lower part, to allow the delivery of the beverage and the subsequent discharge of the used cartridge 14.

In possible implementations, the front semi-shell 32 and the rear semi-shell 34 are kept joined with respect to each other in the assembled configuration of the cartridge transfer slider 20 by means of releasable attachment members 50.

In accordance with embodiments described using FIGS. 9 and 10, the releasable attachment members 50 comprise at least a lever 52. The lever 52 can be connected rotatably around a pin 54 at least on one lateral wall 56 of the front semi-shell 32, in the external part with respect to the concave seating 46.

In possible implementations, the releasable attachment members 50 also comprise at least a coupling element 58, possibly a plurality of coupling elements 58. The coupling element 58 is configured to cooperate with the lever 52 to releasably attach the front semi-shell 32 and the rear semi-shell 34.

According to some embodiments, the lever 52 can have a free end 60 with a hook shape, configured to adapt and connect with the at least one coupling element 58.

In possible implementations, the at least one coupling element 58 can be stably attached at least to a lateral wall 62 of the rear semi-shell 34, in the external part with respect to the concave seating 46, and in correspondence to the side in which the lever 52 is present on the front semi-shell 32.

According to a variant, the at least one coupling element 58, or the coupling elements 58, can be made in a single piece with the rear semi-shell 34.

According to another variant, the releasable attachment members 50 can be positioned in an inverse manner; in particular the lever 52 can be pivoted to the rear semi-shell 34 and the coupling element 58 can be connected to the front semi-shell 32.

According to possible embodiments, there is a lever 52 on each lateral wall 56 of the front semi-shell 32 and a coupling element 58 on each lateral wall 62 of the rear semi-shell 34.

According to a possible variant, the releasable attachment members 50 can be the magnetic type. For example, the releasable attachment members 50 of the magnetic type can comprise a pair of magnetic elements, of which a first magnetic element, with a determinate polarity, can be positioned on the front semi-shell 32 and a second magnetic element, with an opposite polarity to that of the first magnetic element, can be positioned on the rear semi-shell 34. In particular, the first and the second magnetic elements can be positioned in correspondence to the same side of the cartridge transfer slider 20 and at the same relative height, so that in the assembled configuration of the cartridge transfer slider 20, the first and the second magnetic elements are mutually attracted so as to keep the front semi-shell 32 and the rear semi-shell 34 joined.

The magnetic elements can be permanent magnets, for example, such as calamites or electromagnets, or it can be provided that one of the magnetic elements is a calamite, while the other magnetic element is made of a ferromagnetic material that can be attracted by the calamite due to its magnetic characteristics.

In accordance with a possible variant, two pairs of magnetic elements can be provided, each located in correspondence with each side of the front semi-shell 32 and rear semi-shell 34 of the cartridge transfer slider 20.

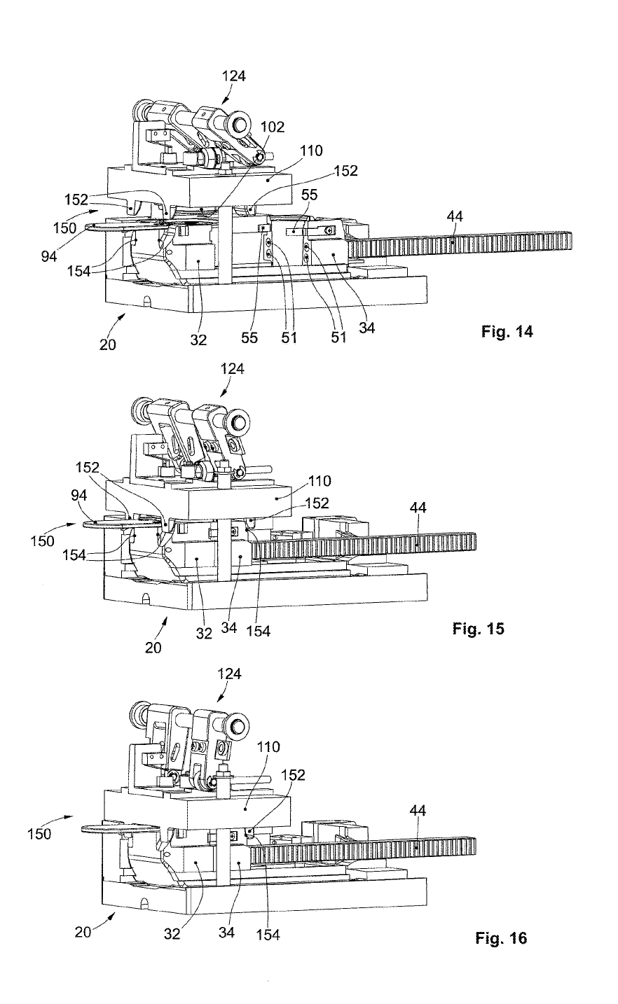

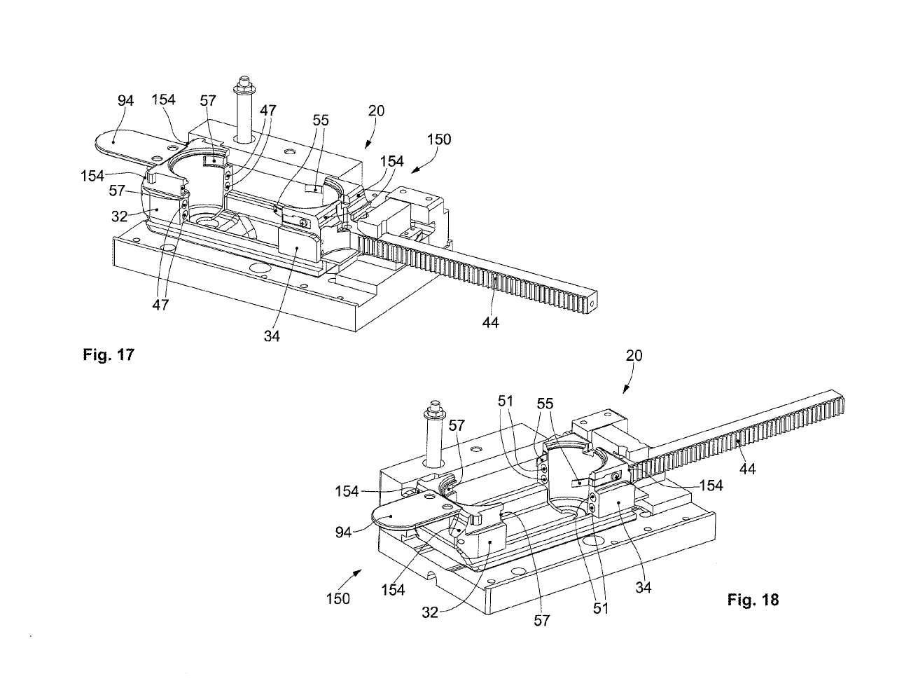

In accordance with embodiments described using FIGS. 14, 17 and 18, and combinable with all the embodiments described here, the releasable attachment members 50 can include a plurality of magnetic elements 47 and corresponding ferromagnetic elements 51, which can respectively be provided on the front semi-shell 32 and on the rear semi-shell 334, or vice versa, or in alternate pairs.

In accordance with embodiments described using FIG. 11, and combinable with all the embodiments described here, the front semi-shell 32 can comprise an ejector element 35, configured so as to facilitate the expulsion of the cartridge 14 when it is in the cartridge expulsion position.

The ejector element 35, in the assembled configuration of the cartridge transfer slider 20, can be confined inside a hollow in the front semi-shell 32, rotatably pivoted inside the hollow.

During the passage from the assembled configuration to disassembled configuration, the ejector element rotates on the pin and, exiting from the hollow, thrusts the cartridge 14.

In accordance with embodiments described using FIGS. 5, 11, 12 and 13, and combinable with all the embodiments described here, one or more elastic drawing or holding elements 55 can be provided, configured to cooperate with a cartridge 14 in the cartridge release configuration in order to discharge a used cartridge 14 from the cartridge transfer slider 20. In possible examples, two elastic drawing elements 55 can be provided, for example disposed symmetrically in the cartridge transfer slider 20. In particular, these one or two elastic drawing elements 55 can be solid with the rear semi-shell 34.

The elastic drawing elements 55 can be configured to act as holding and traction elements of a cartridge 14 in the separation movement of the rear semi-shell 34 with respect to the front semi-shell 32.

The elastic drawing elements 55, obliging the cartridge 14 to follow the rear semi-shell 34 that translates, allow to separate the cartridge 14 from the front semi-shell 32, keeping it temporarily solid with the rear semi-shell 34. After this, beyond a certain force of traction applied, the elastic drawing elements 55 gradually deform, widening, until they yield and no longer hold the cartridge 14 that can thus be expelled, advantageously also by means of the help of an ejector element 37, as will be explained in detail hereafter. For example, the elastic drawing elements 55 can be thin metal blades or foils, in particular elastic springs, more in particular elastic foil springs.

The elastic drawing elements 55 can have an essentially curved shape, advantageously mating with the shape of the lateral surface of the cartridge 14.

In particular the elastic drawing elements 55 can be connected by one end to the lateral walls 62 of the rear semi-shell 34, for example by means of screws 53 or other attachment members. The elastic drawing elements 55 are constrained so that the free ends that extend toward the front semi-shell 32 in the inactive condition are configured to partly surround a cartridge 14.

Since they are elastic at least in correspondence to their free ends, opposite the ends constrained to the front semi-shell 32, the elastic drawing elements 55, if subjected to stresses, can deform, widening toward the outside, to make a cartridge 14 pass that is therefore no longer held by the elastic drawing elements 55. In fact, the elastic drawing elements 55 dilate until the cartridge 14 passes a point of no return, beyond which the cartridge 14 is no longer held by the free ends of the elastic drawing elements 55.

In possible implementations, housing seatings 57 can be provided in the front semi-shell 32, with a complementary shape to that of the elastic drawing elements 55, therefore able to receive and house the elastic drawing elements 55 in the assembled condition of the cartridge transfer slider 20. In this way, the elastic drawing elements 55 can be housed retracted in the front semi-shell 32, adapting to its shape, so as not to impede the insertion of the cartridge 14 in the cartridge transfer slider 20 when the latter is in the assembled condition.

As we said, the elastic drawing elements 55 are configured to at least partly surround the cartridge 14, so as to facilitate its exit from the front semi-shell 32 when the rear semi-shell 34 is translated to pass to the cartridge release configuration of the cartridge transfer slider 20.

In accordance with other embodiments described using FIGS. 10-12, and combinable with all the embodiments described here, an ejector element 37 can also be provided, configured to cooperate with the cartridge 14 when this is translated together with the rear semi-shell 34, determining its detachment. The ejector element 37 can be an alternative or an addition to the ejector element 35 described before.

The ejector element 37 can be stably attached to the inside of the seating 64, in proximity to the upper part. The ejector element 37 can be configured to interfere with the used cartridge 14, in a direction contrary to the translation motion of the cartridge 14, so as to overcome the elastic force of the elastic drawing elements 55 that hold it and make it fall into the cartridge discharge chamber 18 below.

The ejector element 37 can interfere with the cartridge 14, for example by means of a thrust, received or supplied depending on whether it is mobile or fixed. In particular, the ejector element 37 can be stationary, and receive the impact of the cartridge 14, or it can be mobile, and supply a positive thrust on the cartridge 14. The ejector element 37 can be for example a peg, a bar, a pin, a tooth, or similar or comparable element able to interfere linearly with the cartridge 14 in an opposite direction contrary to the motion of the cartridge 14 itself.

According to some embodiments, the rear semi-shell 34 can have, at the rear, a recess or passage channel 63 in correspondence to the groove 48, configured so as to allow the passage of the ejector element 37, so that it can enter into contact with the cartridge 14.

In accordance with embodiments described here, thanks to the presence of the ejector elements 35 or 37, it is thus possible to prevent obstructions in the expulsion of the used cartridges 14 if the cartridges 14 are deformed during the extraction step because of the pressure of the water, or steam injected into it, or because of excessive heat.

In accordance with embodiments described using FIGS. 5-8 and 11, and combinable with all the embodiments described here, the device 10 comprises movement members 22, configured to actuate the movement of the cartridge transfer slider 20 to make it assume at least the cartridge loading position, the beverage extraction position and the cartridge expulsion position.

According to some embodiments, the movement members 22 can comprise a drive member 36 chosen from a group consisting of: an electric motor, a pneumatic motor, a hydraulic piston, a piezoelectric actuator.

The movement members 22 can also comprise motion transfer members 38, able to convert a circular motion into a rectilinear motion. In particular, the movement members 22 are configured to convert the circular motion imparted by the drive member 36 into a rectilinear motion to translate the cartridge transfer slider 20.

The conversion can be commonly done by means of mechanisms selected from a group consisting of: screw actuators, such as jack screws, ball screw actuators and roll screw actuators, or wheel and axis, for example drum, gear, pulley or shaft, actuators, such as a raising cable, a winch, a rack and a pinion unit, a chain transmission, a belt transmission, actuators with rigid chain and rigid belt.

According to embodiments described using FIG. 11, and combinable with all the embodiments described here, the motion transfer members 38 comprise a drive shaft 40. The drive shaft 40 is connected by one end to the drive member 36 and made to rotate solid with the drive member 36. The motion transfer members 38 also comprise a toothed wheel 42, solidly attached to the free end of the drive shaft 40.

The drive member 36 is configured to put the drive shaft 40 into rotation around an axis of rotation X, and the drive shaft 40, in its turn, makes the toothed wheel 42 rotate, which is solidly joined to its end.

In possible implementations, the toothed wheel 42 can be associated with a rack 44, so that the teeth of the toothed wheel 42 engage the teeth of the rack 44. In this way, the rotatory motion of the drive shaft 40 is transformed into a rectilinear motion in a horizontal direction D.

In possible implementations, the rack 44 is solidly attached by screws 45 to the rear semi-shell 34 of the cartridge transfer slider 20 and in this way actuates the movement of the cartridge transfer slider 20, when the cartridge transfer slider 20 is in cartridge support configuration, in particular in the assembled configuration.

When the cartridge transfer slider 20 is in the cartridge release configuration, in particular in the disassembled configuration, the rack 44 actuates the movement of only the rear semi-shell 34, distancing it from or bringing it near to the front semi-shell 32, depending on the direction of rotation of the drive shaft 40 around the axis X (FIG. 11).

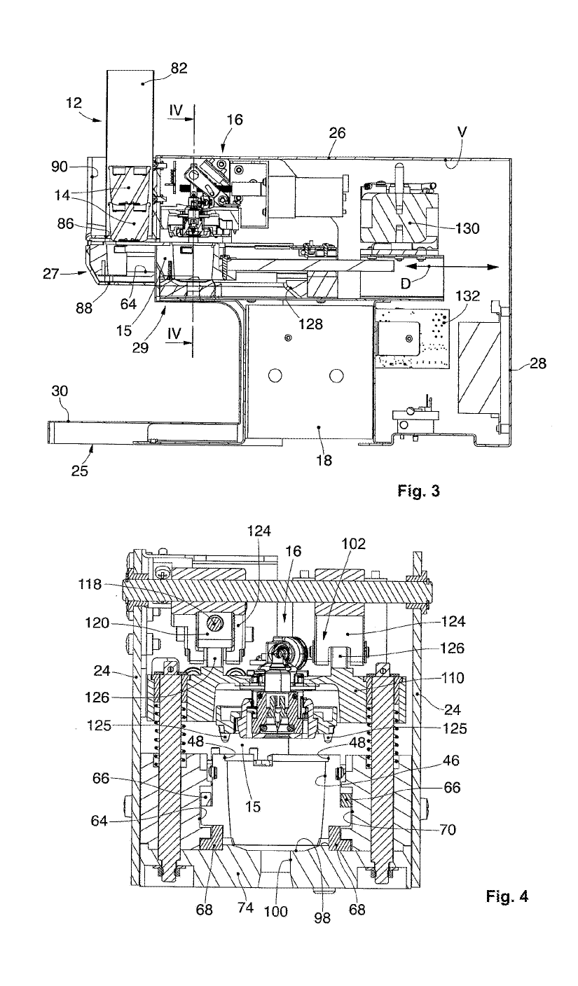

In accordance with embodiments described using FIGS. 3-12, and combinable with all the embodiments described here, a seating 64 is provided, configured to admit the sliding inside it of said cartridge transfer slider 20. To this end, the seating 64 can be delimited laterally by lateral confining elements 66, which define the sliding space of the cartridge transfer slider 20.

In possible implementations, the lateral confining elements 66 can include support elements 68, that protrude slightly toward the inside of the seating 64 and support the cartridge transfer slider 20 laterally during the rectilinear motion in the direction D.

The lateral confining elements 66 can define longitudinally at least one groove 70, in particular a groove 70 in correspondence with each longitudinal wall of the seating 64. Each groove 70 thus defined is conformed so as to cooperate with the releasable attachment members 50, so as to actuate the decoupling of the latter.

According to embodiments described using FIG. 10, and combinable with all the embodiments described here, the groove 70 is substantially of a rectangular shape and disposed horizontally toward the front part 27, while in the direction toward the rear part 28 it has an upward-facing inclination.

In this way, when the movement members 22 move the cartridge transfer slider 20 from the beverage extraction position toward the cartridge expulsion position, the conformation of the groove 70, together with the lateral confining elements 66, invite the lever 52 to rotate around the pin 54, lifting and separating from the coupling element 58.

According to some embodiments, the lateral confining elements 66 can comprise a shaped element 66a, which has an angular shaped end, complementary to the shape of the lever 52. In this way, when it meets the shaped element 66a, the lever 52 is intercepted by this, and forced to rotate around the pin 54.

As a consequence, the front semi-shell 32 and the rear semi-shell 34 are separated and the cartridge transfer slider 20 assumes the disassembled cartridge release configuration.

In accordance with embodiments described using FIG. 13, the front semi-shell 32 comprises in the lower part, in proximity to each lateral wall 56, at least a sliding guide 59 that extends toward the rear part 28. Moreover, the rear semi-shell 34 can be provided with a suitable protruding support element 61 that projects from the lateral wall 62 and rests on the sliding guide 59.

During the passage of the cartridge transfer slider 20 from the cartridge support configuration to the cartridge release configuration, and vice versa, the sliding guide 59 is configured to support the rear semi-shell 34, during its sliding away from and toward the front semi-shell 32.

In particular, two sliding guides 59 can be provided, associated with each lateral wall 56 of the front semi-shell 32, which act as supports for respective protruding support elements 61 provided on each lateral part 62 of the rear semi-shell 34.

According to a variant, not shown in the drawings, the front semi-shell 32 comprises in the lower part, in proximity to each lateral wall 56, a sliding guide 59 that extends toward the rear part 28 and is configured to insert and couple with a suitable hollow provided in the lower apart of the rear semi-shell 34, in correspondence with each lateral wall 62.

In this way, the rear semi-shell 34, translated by the movement members 22, can slide on the sliding guides 59 of the front semi-shell 32, away from or toward the front semi-shell 32, always remaining constrained thereto.

In this way a greater ease of coupling can be provided of the front semi-shell 32 and the rear semi-shell 34 and a greater efficiency in the passage from the cartridge support configuration to the cartridge release configuration of the cartridge transfer slider 20, and vice versa.

According to some embodiments, the front semi-shell 32 can cooperate with holding elements 72, which can render the positioning of the cartridge transfer slider 20 more stable in the cartridge loading position, and/or in the beverage extraction position, and/or facilitate the separation of the front semi-shell 32 from the rear semi-shell 34 in the cartridge expulsion position.

According to embodiments described using FIG. 11, and combinable with all the embodiments described here, the holding elements 72 can be disposed on the front semi-shell 32 and/or on a support base 74 to allow a reciprocal coupling of the front semi-shell 32 and the support base 74.

In possible implementations, the support base 74 can be positioned in alignment with the beverage extraction unit 16, and is inserted between the support elements 68 in the seating 64.

In possible implementations, the holding elements 72 on the front semi-shell 32 can comprise at least a holding seating 76. The holding elements 72 of the support base 74 can also comprise a pin 78, inserted in the support base 74 and elastically connected thereto, for example by means of a spring 80. In this way, when the spring 80 is aligned with the holding seating 76, no longer being subjected to stress, it can extend so as to insert the pin 78 in the holding seating 76.

According to a variant, the pin 78 can be provided on the front semi-shell 32 and the holding seating 76 can be provided on the support base 74.

According to embodiments described using FIG. 11, and combinable with all the embodiments described here, the holding seating 76 can house the pin 78 when the cartridge transfer slider 20 moves from the beverage extraction position, aligned with the beverage extraction unit 16, toward the cartridge expulsion position, that is, toward the cartridge discharge chamber 18.

In this way, the front semi-shell 32 is held while the rear semi-shell 34 continues to move and the cartridge transfer slider 20 passes from the cartridge support configuration, for example assembled (see for example FIGS. 7 and 8) to the cartridge release configuration, for example disassembled (see for example FIGS. 11 and 12).

In possible implementations, the support base 74 can be configured so as to act as end-of-travel for the front semi-shell 32 when it reaches the edge of the cartridge discharge chamber 18.

According to some embodiments, not shown in the drawings and combinable with all the embodiments described here, also the rear semi-shell 34 can comprise holding elements 72 to stabilize the position of the cartridge transfer slider 20 when it is in the cartridge loading position.

In this way, advantageously, the concave seating 46 is perfectly aligned with the cartridge feeder chamber 12 and the cartridge 14, fed by the cartridge feeder chamber 12, can be perfectly inserted in the concave seating 46, resting on the groove 48.

According to embodiments described using FIGS. 5 and 6, and combinable with all the embodiments described here, the front semi-shell 32 can have a shape complementary to the shape of the cartridge feeder chamber 12, so as to be perfectly inserted therein and in this way to align the concave seating 46 with the cartridges 14.

According to some embodiments, the cartridge feeder chamber 12 is configured to contain a plurality of cartridges 14, in particular a pre-determined number of cartridges 14. The cartridge feeder chamber 12 can comprise a cartridge container 82 with a tubular or cylindrical shape, meaning with this term a hollow cylinder, with internal cross section suitable to contain cartridges 14.

In possible implementations, the cartridges 14 inside the cartridge container 82 are disposed stacked one on top of the other. In particular, a column of cartridges 14 is formed inserted in the cartridge container 82, in which the first cartridge 14 is defined as the lowest cartridge in a column of cartridges, that is, the cartridge that is inserted on each occasion into the extraction chamber 15 by means of the cartridge transfer slider 20.

The cartridge container 82 has an upper aperture 84 and a lower aperture 86. The cartridge feeder chamber 12 also comprises a base 88 on which the cartridge transfer slider 20 slides to position itself in the first position.

In correspondence with the front part 27, the cartridge feeder chamber 12 can comprise a vertical eyelet 90 that extends from the upper wall 26 of the device 10 as far as the lower aperture 86 of the cartridge feeder chamber 12.

The vertical eyelet 90 allows to always display the number of cartridges 14 available inside the cartridge feeder chamber 12, so as to immediately realize when they are about to finish.

The number of cartridges 14 that can be contained in the cartridge container 82 can vary depending on the size of the cartridge container 82.

According to one embodiment, the maximum number of cartridges 14 can be, for example, a number greater than two, for example three, four, five, six, seven, eight, nine, ten or even more than ten. It is preferable not to contain an excessive number of cartridges 14 so that they do not remain too long in the cartridge container 82 and their organoleptic properties are not affected. This naturally can also depend on the frequency of preparation and consumption of the beverage.

In accordance with some embodiments, combinable with all the embodiments described here, the upper aperture 84 can be closed by a stopper 92 to protect the cartridges 14 from the external environment and prevent them from deteriorating should they remain unused for a too long period of time.

In accordance with some embodiments, the lower aperture 86 can define a passage or aperture 87 for the cartridges 14, which can selectively pass from a “closed” state to an “open” state.

The passage 87 can be converted from one state to another by means of a mobile closing element 94, configured to separate the cartridges 14 so as to feed the cartridge transfer slider 20 with one cartridge 14 at a time, taking the passage 87 from a “closed” position to an “open” position.

In accordance with embodiments described using FIGS. 5-12, and combinable with all the embodiments described here, the mobile closing mean 94 can be attached to the front semi-shell 32 of the cartridge transfer slider 20.

According to some embodiments, the mobile closing mean 94 can have a shape such as to support the cartridges 14 stacked in the cartridge container 82, preventing them from falling downward due to the force of gravity.

According to embodiments described using FIGS. 5-12, and combinable with all the embodiments described here, the mobile closing mean 94 can have a flat tongue shape, suitable to at least partly block the lower aperture 86 when the transfer slider is in the inactive position, to extract the beverage or to eject the used cartridges 14.

In accordance with some embodiments, in correspondence with the front part 27, the cartridge feeder chamber 12 can comprise a horizontal slit 96 configured so as to allow the passage through it of the mobile closing mean 94 when the cartridge transfer slider 20 is in the cartridge loading position (FIG. 5).

When the cartridge transfer slider 20 moves toward the cartridge loading position, the mobile closing mean 94 takes the passage 87 from the “closed” state to the “open” state.

While the cartridge transfer slider 20 translates toward the beverage extraction position, the mobile closing mean 94 returns the passage 87 to the “closed” state, preventing the remaining cartridges 14 from descending.

According to a variant, not shown in the drawings, the mobile closing mean 94 is included in the cartridge feeder chamber 12. The mobile closing mean 94 can be joined to the cartridge feeder chamber 12 by holding means, for example a spring.

According to this variant, in its motion toward the cartridge loading position, the cartridge transfer slider 20 thrusts the mobile closing mean 94, taking the passage 87 into the “open” state and allowing the passage of a cartridge 14. When the cartridge transfer slider 20 moves toward the beverage extraction position, the spring, no longer subjected to stress, returns the mobile closing mean 94 to its original state, and the passage 87 to the “closed” state.

When the cartridge transfer slider 20 is in the beverage extraction position, the cartridge 14, as well as being supported by the containing seating 26, is also supported by a support seating 98. The support seating 98 is defined on the support base 74, and has a through hole 100 with a sufficient diameter to allow the delivery of the prepared beverage by means of the beverage extraction unit 16.

According to embodiments described using FIGS. 7 and 8, and combinable with all the embodiments described here, the beverage extraction unit 16 comprises an extraction head 102, a hydraulic circuit, configured to take water from a tank (not shown) and to feed the extraction head 102 with hot water under pressure, and positioning members 104, configured to move the extraction head 102 into the desired position.

In particular, said positioning members 104 position the extraction head 102 in proximity to the cartridge 14 present in the cartridge transfer slider 20, when the cartridge transfer slider 20 is in the beverage extraction position.

In accordance with some embodiments, the extraction head 102 is configured so as to cooperate with the cartridge 14, perforating it and thus creating a passage for the water under pressure inside the cartridge 14.

In possible implementations, the extraction head 102 can comprise a pointed end 106 with a shape suitable to perforate the upper part of the cartridge 14 and insert itself therein to create said passage, and to inject hot water under pressure into the cartridge 14.

According to some embodiments, the extraction head 102 can be supported by a support plate, or support deliverer, 110. The extraction head 102 can be housed in a cavity 108 provided in the support plate 110 and configured to be mobile in a vertical direction inside the cavity 108.

The support plate 110, and the extraction head 102 together with it, can move in a vertical direction F (FIGS. 7 and 8) from an inactive position to an extraction position and vice versa. The vertical rectilinear motion of the support plane 106 is actuated by means of a positioning unit 104. The support plate 110, when lowered, in practice closes the cartridge transfer slider 20 at the upper part, in the beverage extraction position of the cartridge 14 inside the extraction chamber 15, allowing the action of the beverage extraction unit 16 to allow the delivery of the beverage.

In accordance with some embodiments, the positioning unit 104 can include a drive member 112, provided with a drive shaft 114, and configured to determine the desired movement of the support plane 106. In possible implementations, the drive member 112 can be, in particular, a motor provided with an intrinsically rotating movement actuator or can be configured to convert a linear movement into a circular movement.

According to some embodiments, the positioning unit 104 also comprises positioning members 116. The positioning members 16 can be associated with the drive shaft 112.

In possible implementations, the positioning members 116 can be configured, in particular, to convert the circular motion of the drive shaft 114 into a rectilinear motion of the support plate 110 in a vertical direction F.

In possible implementations, the positioning members 116 can be mechanisms of the known type, suitable to transfer and convert a circular motion into a rectilinear motion. Types of mechanism can be screw actuators, such as jack screws, ball screw actuators and roll screw actuators, or wheel and axle, for example drum, gear, pulley or shaft, actuators, such as a rack and a pinion unit, a chain transmission, a belt transmission, actuators with a rigid chain and a rigid belt.

In accordance with embodiments described using FIGS. 5-8, and combinable with all the embodiments described here, the positioning members 116 can comprise a worm screw 118. The worm screw 118 is attached to the drive shaft 114 and rotates solidly with the drive shaft 114.

The worm screw 118 can be associated with a connection element 120. The connection element 120 has helical teeth on one side that couple with the worm screw 118 and on the other side has a hole in which a cylinder 122 is stably and solidly inserted.

The connection element 120 is constrained to slide along the worm screw 118 in a horizontal direction, in opposite senses according to the direction of rotation of the worm screw 118 itself.

Two cam elements 124 are engaged on the cylinder 122, one on one side and one on the other with respect to the connection element 120. The cam elements 124 are eccentric elements, slidingly constrained to the support plate 110 by wheel elements 126, so as to thrust the extraction head 102 downward, or take it upward, according to the direction of rotation of the drive shaft 114.

According to some embodiments, combinable with all the embodiments described here, the support plate 110 can comprise protruding elements 125, of a conical shape, with the point facing downward. The protruding elements 125 can cooperate with cavities 127 of a complementary shape present on the front semi-shell 32 and/or on the rear semi-shell 34.

In this way, when the support plate 110 is moved downward, the protruding elements 125 of the support plate 110 can be inserted in the cavities 127 of the cartridge transfer slider 20, achieving a stable coupling of the two elements during the extraction and subsequent delivery of the beverage.

When the extraction head 102 is inserted inside the cartridge 14, it injects hot water into it at a temperature and a pressure defined to prepare the beverage by percolating the water through the powdered substance contained in the cartridge 14.

The prepared beverage flows through the through hole 100 and is collected in an appropriate cup or glass that can be positioned on the support base 30 in correspondence with the front part 27 of the device 10.

In accordance with some embodiments, combinable with all the embodiments described here, in correspondence with the discharge chamber 18, the support base 74 has an expulsion aperture 128, larger than that of a cartridge 14.

The aperture 128 is also configured so as to facilitate the fall of the cartridge 14 into the discharge chamber 18. In fact, in the wall toward the front part 27, the aperture 128 has a wall perpendicular to the direction D in which the cartridge transfer slider 20 moves, in order not to give any support to the cartridge 14. In the wall toward the rear part 28, on the other hand, it has an upturned cone development, in order to widen from the top downward, thus facilitating the passage of the cartridge 14, and ensuring it falls into the discharge chamber 18.

In this way, when the cartridge transfer slider 20 passes from the cartridge support configuration (FIGS. 7 and 8) to the cartridge release configuration (FIGS. 11 and 12) the used cartridge 14, initially in the cartridge transfer slider 20, no longer supported by it, can pass through the expulsion aperture 128, and reach the discharge chamber 18.

In accordance with some embodiments, combinable with all the embodiments described here, after the delivery of the beverage, the cartridge transfer slider 20 translates toward the cartridge expulsion position, moved by means of the movement members 22, in the direction D.

The motion in direction D continues until the holding elements 72 present on the front semi-shell 32 of the cartridge transfer slider 20 and on the support base 74 couple to block the front semi-shell 32.

At the same time, the lateral confining elements 66 cooperate with the releasable attachment members 50 to separate the front semi-shell 32 from the rear semi-shell 34, so that only the front semi-shell 32 continues to translate toward the rear part 28, in order to allow the expulsion of the cartridge 14.

In accordance with some embodiments, combinable with all the embodiments described here, the device 10 can comprise a thermo-block 130, configured to keep the water removed from a tank at a temperature suitable for the percolation of the beverage.

In accordance with some embodiments, combinable with all the embodiments described here, the device 10 can also comprise a non-return electro-valve 132. The electro-valve 132 is configured to prevent the reflux consequent to the injection of hot water under pressure inside the cartridge. In fact, it may happen that, after the injection of water and because of the pressure, water mixed with the beverage can return into the hydraulic circuit, for example water mixed with coffee.

According to some embodiments, the automated feeder device 10 of the cartridges 14 is driven when a user selects a beverage. In particular, a user interface 133 can be provided in the front part 27. This can be provided with command devices 132, for example selection buttons, touch screens, or other means suitable to drive the device 10.

The command devices 132 can be configured to send a signal to a control unit 136, configured to process the signals and to carry out the operations necessary for the delivery of the selected beverage. The control unit 136 can be any data processing system, a controller, a micro-controller, processor, or micro-processor, usable in the field of control, automation or management of a work cycle.

When a user selects a beverage, or an operation to be done, using the command devices 132, these send the data to the control unit 136, which in its turn drives the drive members 36 and 112, configured respectively to move the cartridge transfer slider 20 and the extraction head 102.

Following a command to prepare a beverage, the drive member 36 drives the movement members 22 to move the cartridge transfer slider 20 into the cartridge loading position, in correspondence with the cartridge feeder chamber 12.

In the cartridge loading position, the cartridge transfer slider 20 receives a cartridge 14 from the cartridge feeder chamber 12, then the movement members 22 translate it into the beverage extraction position.

When the cartridge transfer slider 20 is in the beverage extraction position, the drive member 112 is driven and moves the positioning members 116 to thrust the extraction head 102 downward, in order to inject water under pressure into the cartridge 14.

Immediately after injection of the hot water under pressure into the cartridge 14, the direct delivery of the coffee into a suitable cup or glass also occurs.

When the coffee extraction step has finished, the drive member 112 drives the positioning members 116 to return the extraction head 102 upward and the drive member 36 drives the movement members 22 to move the cartridge transfer slider 20 toward the cartridge expulsion position.

When the front semi-shell 32 is clamped by the holding elements 72, the rear semi-shell 34 continues its rectilinear motion in direction D, separating from the front semi-shell 32.

In this way, the cartridge transfer slider 20 passes from the cartridge support configuration to the cartridge release configuration and, no longer having the concave seating 46, allows the cartridge 14 to fall and be discharged.

In this way, advantageously, the device 10 allows to prepare a beverage in an automated manner, without a user having to load the cartridges 14 manually or remove them when they are used.

FIGS. 14, 15, 16, 17 and 18 are used to describe embodiments, combinable with all the embodiments described here, in which the device 10 is provided with a centering system 150 configured to center the cartridge transfer slider 20 with respect to the support plate 110 associated with the extraction head 102.

This aspect advantageously allows to improve the centering of the cartridge transfer slider 20 in the event, for example, of a possible incorrect or inexact alignment thereof with the support plate 110.

A further advantage is found in the reduction of the cycle time of lowering and releasing the support plate 110 and the extraction head 102, since the support plate 110, thanks to the presence of the centering system 150, can start from a lower initial position compared with the solutions in which the centering system 150 is not provided, and there is a reduction both in the descent time and in the ascent time.

In possible implementations, the centering system 150 includes shaped centering elements 152 provided protruding downward on the support plate 110 and mating centering grooves or seatings 154 provided on the cartridge transfer slider 20. The shaped centering elements 152, in the descending travel of the support plate 110 in direction F, accompany the cartridge transfer slider 20 into the correct aligned position. In possible example embodiments, the shaped centering elements 152 can be configured as protruding teeth, in particular shaped as wedges with an internal flare and, in a coordinated manner, the centering grooves 154 can be oblique grooves, shaped mating with the shaped centering elements 152. Advantageously, the centering grooves 154 act as a lead-in for the shaped centering elements 152. The position of the shaped centering elements 152 in the support plate 110 and the position of the centering grooves 154 in the cartridge transfer slider 20 are coordinated, that is, the centering grooves 154 are provided in the same zone of the cartridge transfer slider 20 where the shaped centering elements 152 of the support plate 110 will engage. For example, two, three, four or even more than four shaped centering elements 152 can be provided and a corresponding number of centering grooves 154.

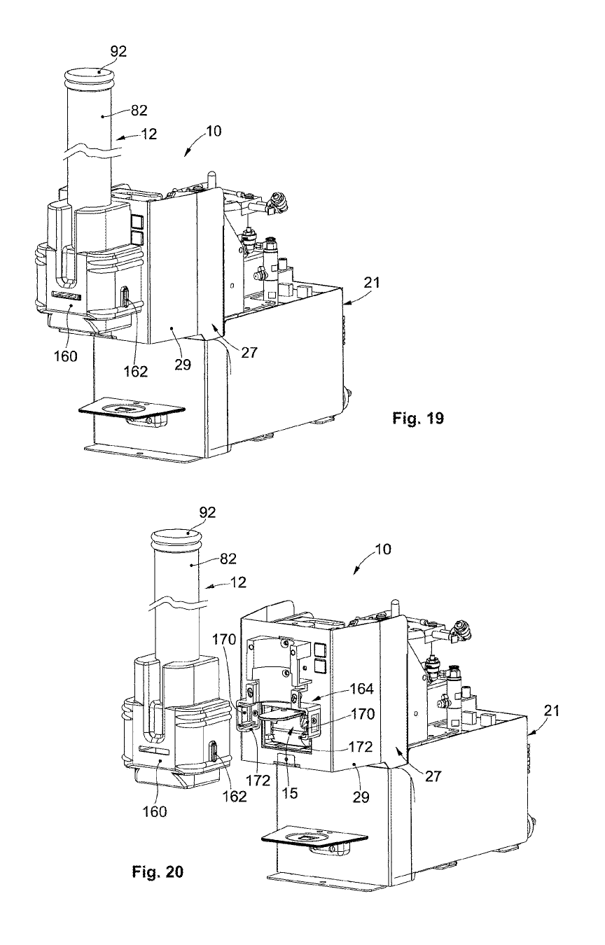

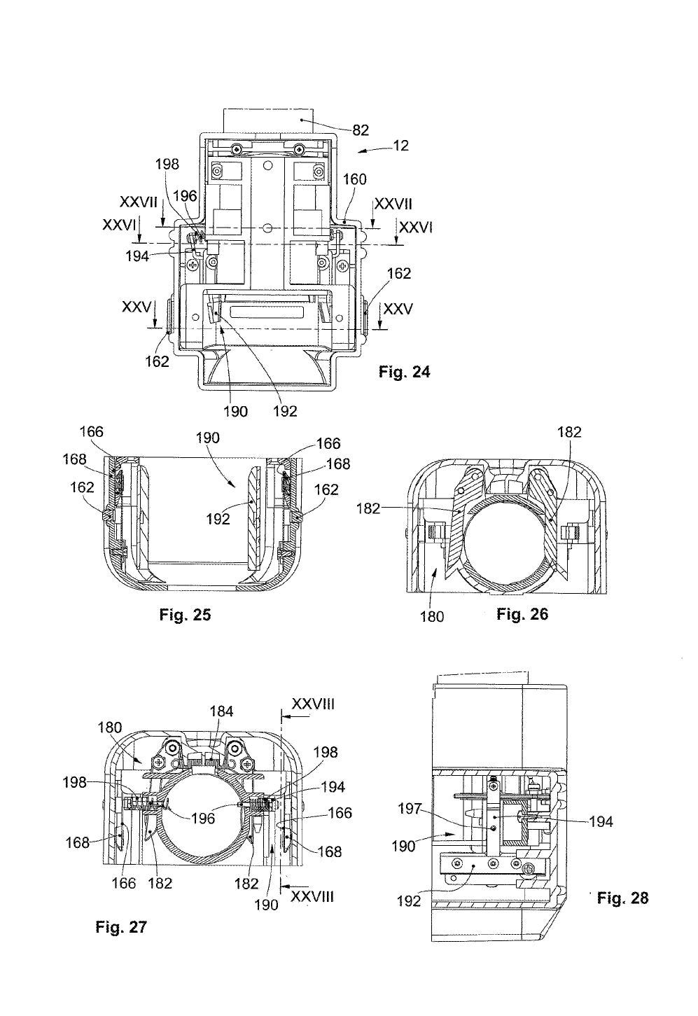

FIGS. 19-28 are used to describe embodiments in which the cartridge feeder chamber 12 is removable. In particular, in possible implementations, the cartridge feeder chamber 12 is removable from the external containing casing 21 of the device 10, in this case from the front part 27 thereof. In particular, the cartridge feeder chamber 12 comprises a removable housing casing 160 able to be releasably connected to the respective external containing casing 21. The removable housing casing 160 can support said cartridge container 82. For the purposes of the releasable connection with the removable housing casing 160, the external containing casing 21 is provided at the front, for example on the front part 27, with a fixed support unit 164 configured to achieve a releasable connection with the removable housing casing 160. To this purpose, in possible implementations, the removable housing casing 160 comprises a pair of attachment blades 166. The attachment blades 166 are advantageously elastic, in order to assist the attachment/detachment of the removable housing casing 160. Moreover, the attachment blades 166 are provided at the ends with stopping wedges 168 and, in a mating manner, the fixed support unit 164 is provided with coordinated attachment seatings 170. The stopping wedges 168 are configured to selectively engage the attachment seatings 170. Moreover, the fixed support unit 164 is preferably provided with alignment guides 172.

The removable housing casing 160 is provided with a pair of blocking/unblocking buttons 162 disposed in correspondence to said attachment blades 166. By means of the blocking/unblocking buttons 162 it is possible to block/unblock the removable housing casing 160 with respect to the fixed support unit 164. In particular, to remove the removable housing casing 160 from the fixed support unit 164, the removable housing casing 160 can be gripped and, pulling it toward the outside, the blocking/unblocking buttons 162 pressed. The latter act on the two respective attachment blades 166 which, being pressed, cause the disengagement of the two stopping wedges 168 at the ends from the attachment seatings 170, allowing to remove the removable housing casing 160 from the external containing casing 21. To re-position the cartridge feeder chamber 12, it is sufficient to position the removable housing casing 160 with respect to the fixed support unit 164 so that the attachment blades 166 and the respective stopping wedges 168 at the ends are aligned with said alignment guides 172, and thrust the removable housing seating 160 until the stopping wedges 168 and the attachment seatings 170 are engaged.

The embodiments in which the cartridge feeder chamber 12 is removable from the external containing casing 21 are advantageous since, being able to remove the cartridge feeder chamber 12, it is possible to have direct access to the inside of the extraction chamber 15 to be able to intervene manually or with a tool, for example in the case of a blockage or obstruction of a cartridge 14 or other problem that prevents the correct operation of the device 10 in the extraction chamber 15, or for cleaning and/or maintenance.

FIGS. 19-28 are used to describe other embodiments, combinable with all the embodiments described here, in which the cartridge feeder chamber 12 is provided with a first cartridge holding system 180 configured to selectively block the first cartridge that is at the lowest point in the column of cartridges inserted in the cartridge container 82. This aspect is advantageous for example in combination with the embodiments in which the cartridge feeder chamber 12 is removable, since it allows the removal of the latter without having to empty the cartridge container 82. In this way, when the cartridge feeder chamber 12 is removed, the cartridges 14 are prevented from falling from the bottom. Advantageously, the first cartridge holding system 180 is selectively activated and deactivated when the cartridge feeder chamber 12 is respectively removed and connected to the external containing casing 21.

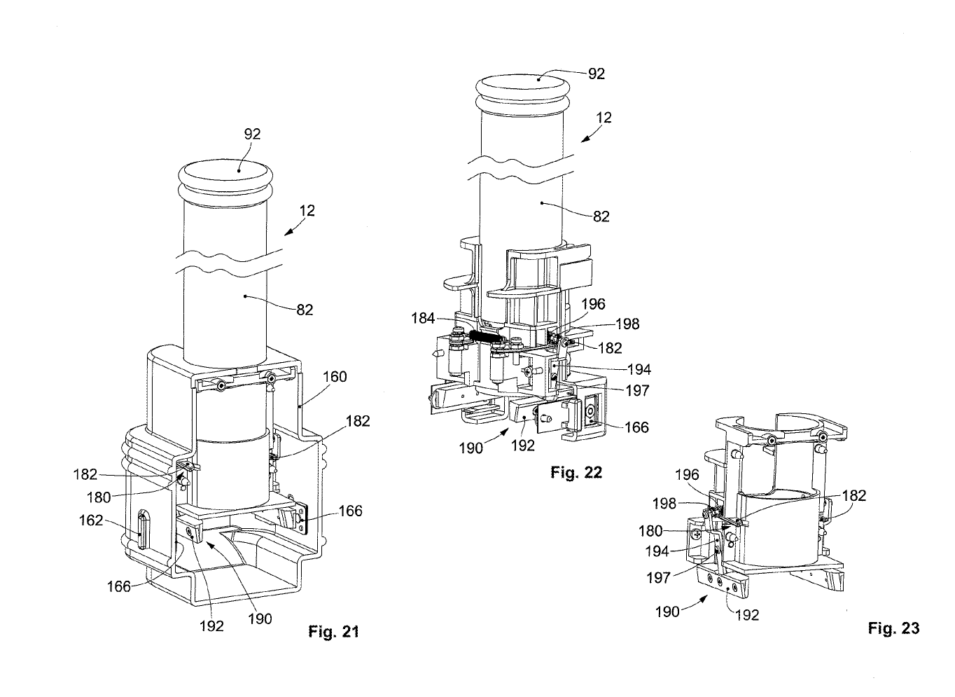

In possible embodiments, the first cartridge holding system 180 comprises two first cartridge holding blades 182 (FIGS. 21, 22, 23, 26 and 27) configured as jaws or grippers and commanded by a spring 184 (FIGS. 22 and 27). The two first cartridge holding blades 182 are disposed in the removable housing casing 160 at a height corresponding to the height where there is the upper crown or lid of the first cartridge.

The first cartridge holding system 180 functions as follows. When the removable housing casing 160 is connected to the fixed support unit 164, the two first cartridge holding blades 182 are kept distanced from the first cartridge thanks to the shape and geometry of the fixed support unit 164, so that they do not interfere with the normal loading of the cartridge 14 in the extraction chamber 15 by the cartridge transfer slider 20. Instead, when the removable housing casing 160 is extracted from the fixed support unit 164, the two first cartridge holding blades 182, thanks to the action of the spring 184, automatically move near to the first cartridge, gripping it and clamping it. In this way, the cartridges 14 are prevented from coming out of the cartridge container 82 from the lower part when the cartridge feeder chamber 12 is disconnected and removed from the external containing casing 21.

FIGS. 19-28 are used to describe other embodiments, combinable with all the embodiments described here, in which the cartridge feeder chamber 12 is provided with a second cartridge holding system 190, configured to selectively clamp the second cartridge, that is, the one directly above the first cartridge in the column of cartridges inserted in the cartridge container 82. This aspect prevents the second cartridge from interfering with the first cartridge when the latter is inserted in the cartridge transfer slider 20 to be positioned in the extraction chamber 15. The second cartridge holding system 190 is disposed in the removable housing casing 160. In possible implementations, the second cartridge holding system 190 includes at least a mobile shoe 192 (see for example FIGS. 21, 23, 24, 25, 28), which is connected to and commands a respective drive lever 194 (see for example FIGS. 22, 23, 24 and 28). The drive lever 194 is pivoted in a substantially median zone by a pivoting element 197. Moreover, the drive lever 194 is provided at an opposite end with a stopping element 196 located transverse. For example, the stopping element 196 can be a peg, a pin, a cylinder, a small plate, a tongue or similar. A spring 198 is fitted onto the stopping element 196. The stopping element 196 is transverse to the drive lever 194, and faces toward the inside, that is, toward the zone where there is the second cartridge, and is able to engage the latter, holding it. A similar group of components, including the mobile shoe 192, drive lever 194 and stopping element 196, can possibly be provided on the opposite side with respect to the column of cartridges.

The second cartridge holding system 190 functions as follows. When the cartridge transfer slider 20 proceeds in the loading travel of the first cartridge, it thrusts the mobile shoe 192 toward the outside, in particular by a desired travel. Consequently, the drive lever 194, to which the mobile shoe 192 is connected, moves away in its lower part and, being pivoted in a substantially median zone, moves the stopping element 196 near to the second cartridge, clamping it mechanically, in particular a little below its upper crown or cover, preventing it disturbing or interfering with the first cartridge below. After this, the cartridge transfer slider 20 proceeds with loading the first cartridge and, in the return travel, the mobile shoe 192, no longer thrust toward the outside by the cartridge transfer slider 20, returns to the inactive position, so that the drive lever 194 also counter-rotates and, distancing its upper part, disengages the stopping element 196 from the second cartridge, which is freed and, falling due to gravity, can take the place that was occupied by the first cartridge, thus becoming the first cartridge for subsequent use. In particular, the thrust of the cartridge transfer slider 20 against the mobile shoe 192 occurs against the elastic force of the spring 198, determining the compression thereof, while, when there is no longer any thrust on the mobile shoe 192, the spring 198 elastically returns the drive lever 194 into position and therefore the stopping element 196 no longer interferes with the second cartridge.

It is clear that modifications and/or additions of parts may be made to the automated device 10 for the preparation of beverages from cartridges described heretofore, without departing from the field and scope of the present invention.

It is also clear that, although the present invention has been described with reference to some specific examples, a person of skill in the art shall certainly be able to achieve many other equivalent forms of automated device for the preparation of beverages from cartridges, having the characteristics as set forth in the claims and hence all coming within the field of protection defined thereby.

Although the above refers to embodiments of the invention, other embodiments can be provided without departing from the main field of protection, which is defined by the following claims.

In the following claims, the sole purpose of the references in brackets is to facilitate reading: they must not be considered as restrictive factors with regard to the field of protection claimed in the specific claims.

1. Automated device to prepare beverages from cartridges comprising a beverage extraction unit configured to extract and deliver the beverage from a cartridge, comprising:
a cartridge feeder chamber configured to contain and supply a plurality of cartridges,
a cartridge transfer slider, automatically mobile between at least:
a cartridge loading position, in correspondence with said cartridge feeder chamber, to receive a cartridge;
a beverage extraction position, different from the cartridge loading position, aligned with said beverage extraction unit;
a cartridge expulsion position, different from the cartridge loading position and from the beverage extraction position,
wherein said cartridge transfer slider has, both in said cartridge loading position and in said beverage extraction position, a cartridge support configuration, and also has, in said cartridge expulsion position, a cartridge release configuration to discharge a used cartridge.

2. Device as in claim 1, wherein said cartridge transfer slider comprises a front semi-shell and a rear semi-shell that, when they are joined, define said cartridge support configuration of the cartridge transfer slider and define a concave seating configured to support said cartridge and, when they are separated, define said cartridge release configuration of said cartridge transfer slider and allow the discharge of said cartridge.

3. Device as in claim 2, wherein said front semi-shell and said rear semi-shell are joined by means of releasable attachment members.

4. Device as in claim 3, wherein said releasable attachment members comprise at least one lever, rotatably pivoted on a pin and attached to said front semi-shell, and at least one coupling element attached to said rear semi-shell and configured to couple with said lever to keep said front semi-shell joined to said rear semi-shell.

5. Device as in claim 3, wherein said releasable attachment members are of the magnetic type.

6. Device as in claim 1, wherein said device comprises movement members configured to move said cartridge transfer slider to assume at least said cartridge loading position, said beverage extraction position and said cartridge expulsion position.

7. Device as in claim 3, and further comprising a seating suitable to allow a sliding movement of said cartridge transfer slider inside it, said seating being delimited by lateral confinement elements that define at least one groove provided to cooperate with said releasable attachment members and said movement members, in order to separate said front semi-shell from said rear semi-shell.

8. Device as in claim 6, wherein said movement members comprise a drive member configured to drive motion transfer members connected to said cartridge transfer slider and configured to transform the rotatory motion supplied by said drive member into a rectilinear motion of said cartridge transfer slider.

9. Device as in claim 8, wherein said motion transfer members comprise a drive shaft made to rotate by said drive member, a toothed wheel attached to said drive shaft and that rotates solid with said drive shaft and a rack, that is solidly attached to said cartridge transfer slider and cooperates with said toothed wheel to transform the rotatory motion of said drive shaft into a rectilinear motion of said cartridge transfer slider.

10. Device as in claim 1, wherein said device comprises a support base configured to cooperate with said cartridge transfer slider by means of holding elements to stabilize the positioning of said cartridge transfer slider in the cartridge loading position and/or beverage extraction position and/or for the separation of the front semi-shell from the rear semi-shell in the cartridge expulsion position.

11. Device as in claim 1, wherein said cartridge feeder chamber comprises a cylindrical container configured to contain a plurality of cartridges stacked one on top of the other, and provided with a lower aperture that can be selectively opened or closed by means of a mobile closing element.

12. Device as in claim 11, wherein said mobile closing element has a flat tongue shape, configured to at least partly close said lower aperture and is attached to the front semi-shell so as to open said lower aperture during the translation of the cartridge transfer slider toward the cartridge loading position.

13. Device as in claim 1, wherein said beverage extraction unit comprises an extraction head, configured to extract a beverage from said cartridge, and a positioning unit configured to position said extraction head in proximity to said cartridge when the cartridge transfer slider is in the beverage extraction position.

14. Device as in claim 13, wherein said device comprises a support plate configured to support said extraction head.

15. Device as in claim 13, wherein said positioning unit comprises a drive member, provided with a drive shaft, and positioning members, connected to said extraction head and configured to transform the rotatory motion of said drive shaft into a rectilinear motion of said extraction head in a vertical direction.

16. Device as in claim 14, wherein said positioning members comprise a worm screw solidly attached to said drive shaft, a connection element with helical teeth on one side that couple to said worm screw and on the other side a hole in which a cylinder is solidly inserted on which cam elements are engaged, slidingly constrained to said support plane by means of wheel elements in order to move said extraction head in said vertical direction according to the direction of rotation of said cylinder.

17. Device as in claim 1, comprising one or more elastic drawing elements configured to cooperate with a cartridge in the cartridge release configuration in order to discharge a used cartridge from the cartridge transfer slider.

18. Device as in claim 1, wherein said device comprises one or more ejector elements configured to act on the cartridge, determining its expulsion.

19. Device as in claim 14, wherein said device comprises a centering system configured to center the cartridge transfer slider with respect to the support plate associated with the extraction head.

20. Device as in claim 1, wherein said cartridge feeder chamber is removable.

21. Device as in claim 1, wherein said device comprises a first cartridge holding system configured to selectively hold a first cartridge disposed in a lower position in a column of cartridges present in the cartridge feeder chamber.

22. Device as in claim 1, wherein said device comprises a second cartridge holding system configured to selectively hold a second cartridge disposed directly above a first cartridge disposed in a lower position in a column of cartridges present in the cartridge feeder chamber.

23. Cartridge transfer slider for an automated device for the preparation of beverages from cartridges, said slider being configured mobile and having at least:
a cartridge loading position, to receive a cartridge,
a beverage extraction position, different from said cartridge loading position;
said cartridge transfer slider having, both in said cartridge loading position and in said beverage extraction position, a cartridge support configuration,
a cartridge expulsion position, different from the cartridge loading position and from the beverage extraction position, wherein said cartridge transfer slider has a cartridge release configuration for the discharge of said used cartridge.

24. Transfer slider as in claim 23, wherein said cartridge transfer slider comprises a front semi-shell and a rear semi-shell that, when they are joined, define said cartridge support configuration of the transfer slider and define a concave seating configured to support said cartridge and, when they are separated, define said cartridge release configuration of said cartridge transfer slider and allow the discharge of said cartridge.

25. Automated method for the preparation of beverages from cartridges comprising the extraction of a beverage from a cartridge by means of a beverage extraction unit, wherein said method comprises:
containing and supplying a plurality of cartridges using a cartridge feeder chamber,
automatically receiving a cartridge in a cartridge loading position, in correspondence with said cartridge feeder chamber;
automatically transferring the cartridge into a beverage extraction position, aligned with said beverage extraction unit and different from said cartridge loading position, for the extraction and delivery of the beverage;
after the extraction, automatically transferring the used cartridge into a cartridge expulsion position, different from the cartridge loading position and from the beverage extraction position, in which to discharge said cartridge.
